(19) United States
(12) Patent Application Publication
(10) Pub. No.: US 2023/0046379 A1
(43) Pub. Date: Feb. 16, 2023

(54) Factory Management Device, Factory Management Method, and Factory Management Program

(71) Applicant: Hitachi, Ltd., Chiyoda-ku, Tokyo (JP)

(72) Inventors: Takahiro NAKANO, Tokyo (JP); Daisuke TSUTSUMI, Tokyo (JP); Yumiko UENO, Tokyo (JP)

(21) Appl. No.: 17/794,514

(22) PCT Filed: Sep. 8, 2020
(86) PCT No.: PCT/JP2020/033856

§ 371 Date: Jul. 21, 2022

(30) Foreign Application Priority Data
Jan. 22, 2020 (JP) 2020-008535

(51) Int. Cl. G05B 19/418

(52) U.S. Cl. CPC G05B 19/41885

(57) ABSTRACT

A function to optimize factory management using information on operation ability and capability of an operator and a machine is provided.

Provided is a factory management device which makes a plan for a factory, the device including a storage unit which stores operator measurement information obtained by measuring a movement of an operator and machine measurement information obtained by measuring a predetermined value which indicates an operating state of a machine that is production equipment of the factory, an operator ability prediction unit which predicts changes in operation ability of the operator using the operator measurement information, a machine capability prediction unit which predicts changes in operation capability of the machine using the machine measurement information, a production capacity prediction unit which predicts a production capacity of the factory using prediction of changes in the operation ability and capability of the operator and the machine, and a planning unit which makes a plan for the factory that satisfies a predetermined productivity index using the predicted production capacity of the factory.

### TECHNICAL FIELD

The present invention relates to a factory management device, a factory management method, and a factory management program. The present invention claims the priority of Japanese Patent Application No. 2020-008535 filed on Jan. 22, 2020, and for designated countries in which the present invention is permitted to be incorporated by reference in the literature, the contents described in the application are incorporated into the present application by reference.

### BACKGROUND ART

JP-A-2018-025932 (PTL 1) discloses an operation management system including a sensor for acquiring data of an operator and a cell control device connected to the sensor, in which calculation of state information of an operator's fatigue level, proficiency level, and interest level from an operator's movement amount and state amount is performed and transmission of the state information is performed.

### CITATION LIST

### Patent Literature

PTL 1: JP-A-2018-025932

### SUMMARY OF INVENTION

### Technical Problem

In the technique described in PTL 1 described above, the state information of the operator is calculated from the data of the sensor attached to the operator, and the state information is transmitted. However, since it is not possible to grasp a state of a machine in a factory, it is not possible to control the entire production capacity of the factory. Therefore, there is a problem in that management accuracy of the production capacity and accuracy of production planning deteriorate, and thus an operation delay occurs and manufacturing costs increase.

An object of the present invention is made in consideration of the above points, and an object of the present invention is to provide a function of optimizing management of a factory by using information on operation ability and capability of an operator and a machine.

### Solution to Problem

The present application includes a plurality of means for solving at least a part of the problems described above, and if an example is given, it is a factory management device which makes a plan for a factory, the factory management device including a storage unit which stores operator measurement information obtained by measuring a movement of an operator and machine measurement information obtained by measuring a predetermined value which indicates an operating state of a machine that is production equipment of the factory, an operator ability prediction unit which predicts changes in operation ability of the operator using the operator measurement information, a machine capability prediction unit which predicts changes in operation capability of the machine using the machine measurement information, a production capacity prediction unit which predicts a production capacity of the factory using prediction of changes in the operation ability and capability of the operator and the machine, and a planning unit which makes a plan for the factory that satisfies a predetermined productivity index using the predicted production capacity of the factory.

### Advantageous Effects of Invention

According to the present invention, it is possible to provide a technique for optimizing management of a factory by using information on operation ability and capability of an operator and a machine.

Problems, configurations, and effects other than those described above will be clarified by the following description of the embodiments.

### BRIEF DESCRIPTION OF DRAWINGS

FIG. 1 is a diagram illustrating a configuration example of a factory management device according to a first embodiment;

FIG. 2 is a diagram illustrating a hardware configuration example of the factory management device;

FIG. 3 is a diagram illustrating an example of a flow of a factory planning process;

FIG. 4 is a diagram illustrating an example of a data structure of operator measurement information;

FIG. 5 is a diagram illustrating an example of a data structure of machine measurement information;

FIG. 6 is a diagram illustrating an example of a data structure of production resource information (operator);

FIG. 7 is a diagram illustrating an example of a data structure of production resource information (machine);

FIG. 8 is a diagram illustrating an example of a data structure of product quantity information;

FIG. 8 is a diagram illustrating an example of a data structure of production process information;

FIG. 10 is a diagram illustrating an example of a data structure of predicted operator ability (operation time);

FIG. 11 is a diagram illustrating an example of a data structure of predicted operator ability (motivation);

FIG. 12 is a diagram illustrating an example of a data structure of predicted machine capability (deterioration degree);

FIG. 13 is a diagram illustrating an example of a data structure of predicted machine capability (operation time);

FIG. 14 is a diagram illustrating an example of a flow of a factory production capacity prediction process;

FIG. 15 is a diagram illustrating a configuration example of a production planning screen;

FIG. 16 is a diagram illustrating a configuration example of a production capacity prediction screen;

FIG. 17 is a diagram illustrating an example of a flow of a planning process;

FIG. 18 is a diagram illustrating a configuration example of an education plan screen; and

FIG. 19 is a diagram illustrating a configuration example of a maintenance plan screen.

### DESCRIPTION OF EMBODIMENTS

In the following embodiment, when it is necessary for convenience, the description will be divided into a plurality of sections or embodiments. However, unless otherwise specified, they are not unrelated to each other, one is related to some or all of the other variants, details, supplementary explanations, and the like.

Further, in the following embodiment, when the number (including the number, numerical value, quantity, range, and the like) of elements is referred to, the number is not limited to the specific number, and may be equal to or more than or equal to or less than the specific number, except when explicitly stated or when the number is clearly limited to the specific number in principle.

Further, in the following embodiment, it goes without saying that the constituent elements (including element steps and the like) are not necessarily essential unless otherwise specified or clearly considered to be essential in principle.

Similarly, in the following embodiment, when referring to the shape, the positional relationship, and the like of the constituent elements, and the likes except when explicitly stated and when it is considered that this is not the case in principle, it shall include those that are substantially similar to the shape, or the like. This also applies to the above-described numerical values and ranges.

Further, in all the drawings for illustrating the embodiment, in principle, the same members are designated by the same reference numerals, and the repeated description thereof will be omitted. However, even when the same member is used, when there is a high risk of causing confusion if the name is shared with a member before the change due to an environmental change or the like, another different reference numeral or name may be given. Hereinafter, each embodiment of the present invention will be described with reference to the drawings.

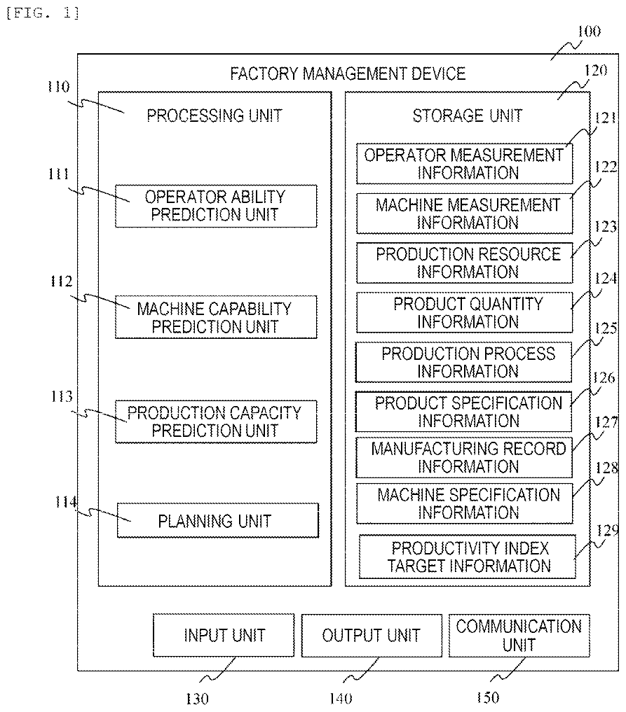

FIG. 1 is a diagram illustrating a configuration example of a factory management device according to a first embodiment. A factory management device 100 includes a processing unit 110, a storage unit 120, an input unit 130, an output unit 140, and a communication unit 150.

The processing unit 110 includes an operator ability prediction unit 111, a machine capability prediction unit 112, a production capacity prediction unit 113, and a planning unit 114. The storage unit 120 includes operator measurement information 121, machine measurement information 122, production resource information 123, product quantity information 124, production process information 125, product specification information 126, manufacturing record information 127, machine specification information 128, and productivity index target information 129.

The operator measurement information 121 is measurement data which records a state of an operator acquired by an image sensor, a three-dimensional sensor, or the like. For example, it is a time-series measurement value of the three-dimensional coordinate values in each reference axis based on a skeleton model of the operator imaged by a three-dimensional measuring machine.

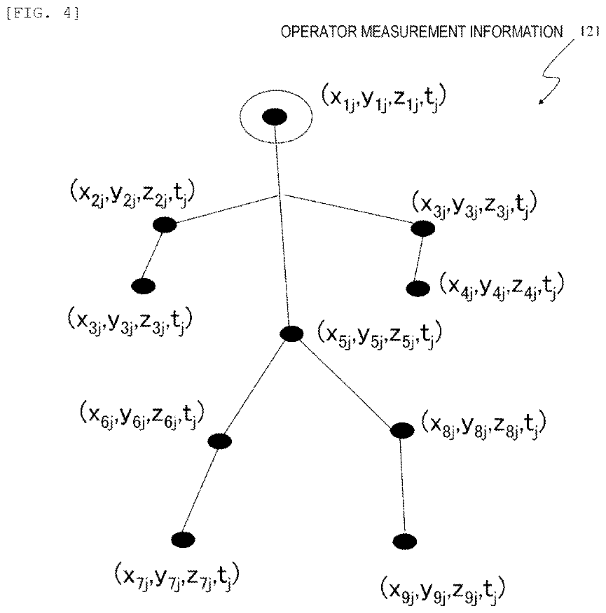

FIG. 4 is a diagram illustrating an example of a data structure of the operator measurement information. As illustrated in the figure, in the operator measurement information 121, the three-dimensional coordinate values (x, y, z) and the time information (tⱼ) in each reference axis (head, right elbow, right hand, left elbow, left hand, hip, right knee, right foot, left knee, left foot, and the like) based on the skeleton model of the operator imaged by the three-dimensional measuring machine are combined and stored as the measured values.

The machine measurement information 122 is measurement data which records a state of a machine related to production, that is, the state of a machine that is a production facility, acquired by a current sensor, a vibration sensor, or the like. For example, the measured value is the current value for each time series flowing through the machine.

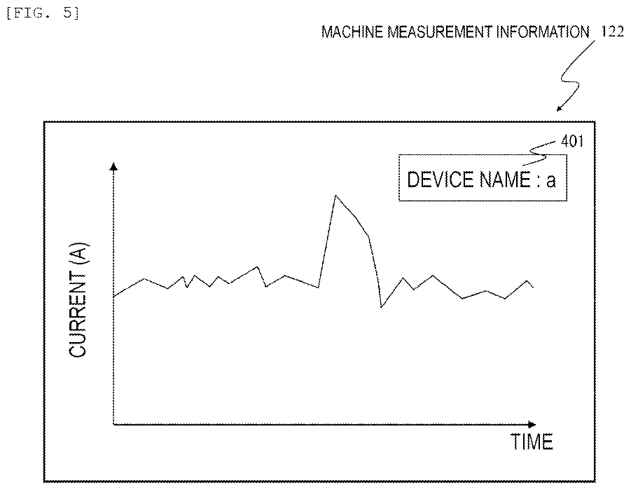

FIG. 5 is a diagram illustrating an example of a data structure of the machine measurement information. As illustrated in the figure, the machine measurement information 122 stores a current value (A) of the machine specified by a device column 401 in time series as a measurement value.

The production resource information 123 includes a production resource of the operator and a production resource of the machine. When distinguishing between the two, it is described as the production resource information (operator) 123 and production resource information (machine) 123, and when it is described as the production resource information 123, it is a general term that does not distinguish between the two.

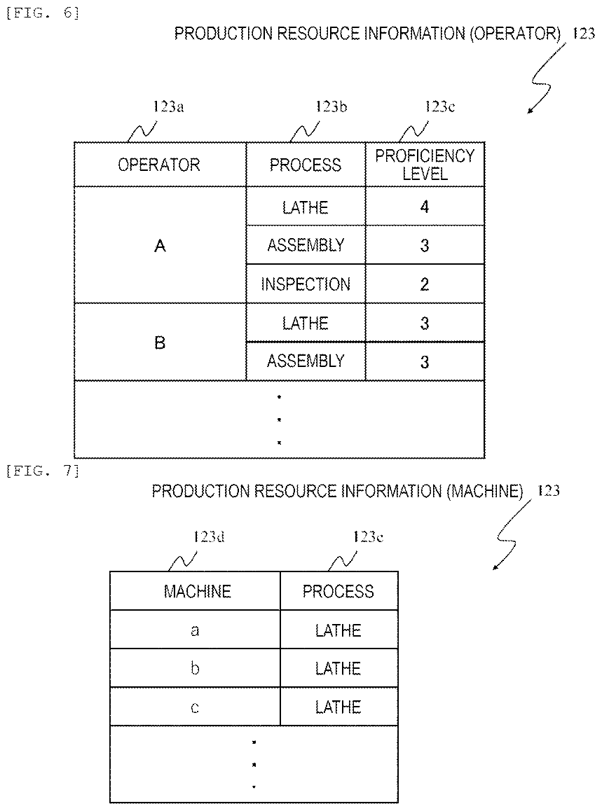

FIG. 6 is a diagram illustrating an example of a data structure of the production resource information (operator). In the production resource information (operator) 123, an operator 123a, a process 123b, and a proficiency level 123c are stored in association with each other. The operator 123a is information which identifies an individual engaged in the operation. The process 123b is information for specifying the process in charge. The proficiency level 123c is information indicating by a predetermined value the ability expected when the operator specified by the operator 123a is in charge of the process specified in the process 123b.

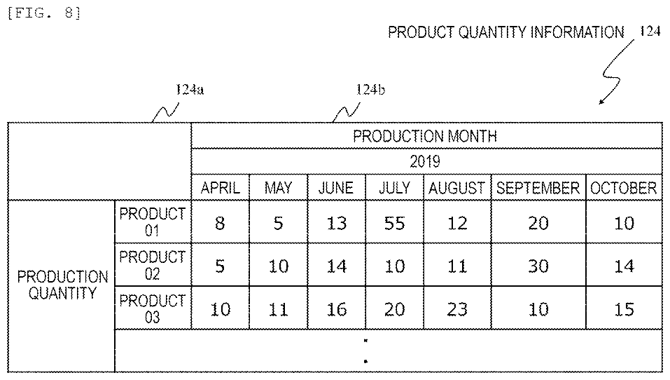

FIG. 7 is a diagram illustrating an example of a data structure of the production resource information (machine). In the production resource information (machine) 123, a machine 123d and a process 123e are stored in association with each other. The machine 123d is information which identifies the machine used for the operation. The process 123e is information for specifying the process in charge.

The product quantity information 124 is information indicating the quantity of products that the factory plans to produce. For example, the product quantity information 124 is information for specifying the product quantity for each product in a planned production month.

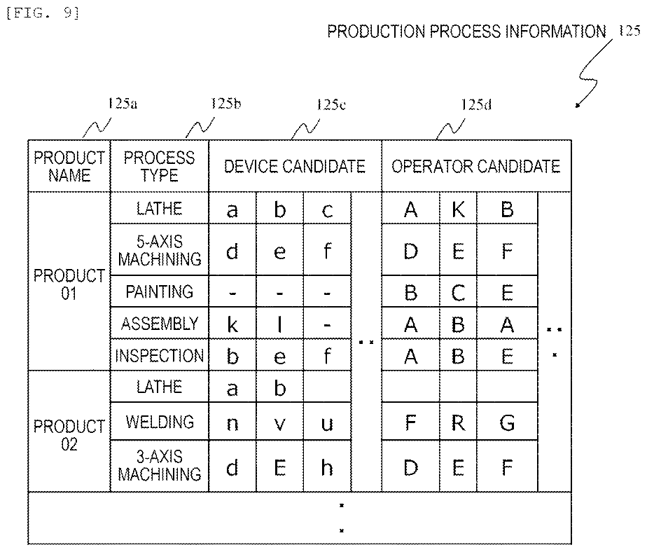

FIG. 8 is a diagram illustrating an example of a data structure of the product quantity information. The product quantity information 124 includes a product quantity 124a for each product and a production month 124b. The product amount 124a is information for specifying the amount of the product to be produced at the period (the one month) specified in the production month 124b.

The production process information 125 is information indicating the method, order, candidate of machine (production device) to foe used, candidate of operator, and the like of the production process such as processing and assembly of the product to foe produced.

FIG. 9 is a diagram illustrating an example of a data structure of the production process information. The production process information 125 includes a product name 125a which specifies the product name of a production target object, a process type 125b which specifies the process, a device candidate 125c which lists candidates for production devices when there are the candidates for production devices that can be used in the process, and an operator candidate 125d which lists operator candidates when there are the operator candidates who can take charge of the process.

The product specification information 126 is data indicating product specifications including product design information and material information. The manufacturing record information 127 is information including the process of the product manufactured in the past, the allocation result of the operator and the machine, the operation time, and the operation quality. The machine specification information 123 is information including specification information such as a power supply, a size, a movement amount, and a rotation speed of a machine (production device) specified by the machine 123d of the production resource information (machine) 123. The productivity index target information 129 is a target value of various productivity indices (Key Performance Indicator: KPI) such as production throughput, manufacturing cost, and operator's satisfaction degrees.

The operator ability prediction unit 111 predicts the operation ability of the operator by using the operator measurement information 121, the product specification information 126, and the manufacturing record information 127. The operator ability prediction unit 111 predicts the operation ability of the operator by analyzing the effect of changes in the operator measurement information 121 on the manufacturing record information 127 for any of the products specified by the product specification information 126.

For example, for a product that tends to have a high manufacturing record when the movement amount of a predetermined part is reduced and the movement speed is high, when the measurement information of the operator has the same tendency, the operator ability prediction unit 111 highly predicts the manufacturing record and also the operator ability.

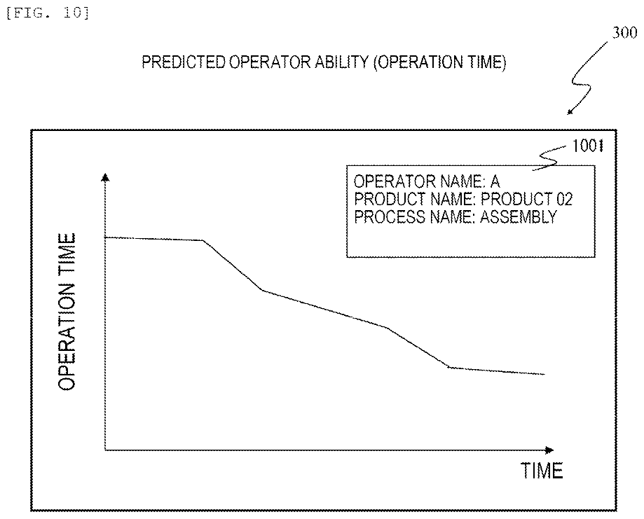

FIG. 10 is a diagram illustrating an example of a data structure of a predicted operator ability (operation time). As illustrated in the figure, an operator ability model 300 is a set of information that predicts how the operation time for operating the process will change in the future for specific information 1001 for each operator, product, and process. As a basic tendency, operators tend to have shorter operation time due to their proficiency, so the higher the proficiency level, the shorter the operation time.

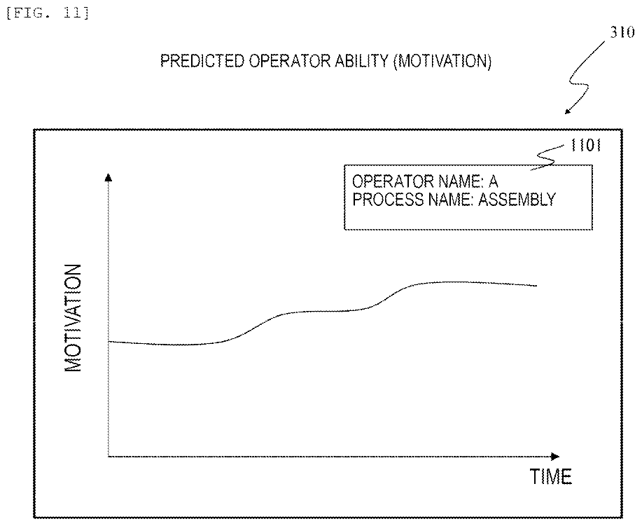

FIG. 11 is a diagram illustrating an example of a data structure of the predicted operator ability (motivation). As illustrated in the figure, an operator ability model 310 is a set of information that predicts how the motivation to operate the process will change in the future with respect to a specific information 1101 for each operator and process In the prediction of motivation, the operator ability prediction unit ill collects psychological and subjective information (questionnaire response results) by a series of operations in the operator measurement information 121 or a questionnaire added at regular intervals. The operator ability prediction unit 111 analyzes a correlation between the operator measurement information 121 and the psychological and subjective information (questionnaire response results), and predicts changes in the subjective motivation. As a basic tendency, operators tend to have fluctuations in motivation due to proficiency, repetition, and other psychological factors.

The machine capability prediction unit 112 predicts the operation capability of the machine by using the machine measurement information 122, the product specification information 126, and the manufacturing record information 127. The machine capability prediction unit 112 predicts the operation capability of a machine by analyzing the effect of changes in the machine measurement, information 122 on the manufacturing record information 127 for any of the products specified by the product specification information 126.

For example, for a product that tends to have a high manufacturing record when the current value of a predetermined machine is high, when the measurement information of the machine has the same tendency, the machine capability prediction unit 112 highly predicts the manufacturing record and also the machine capability.

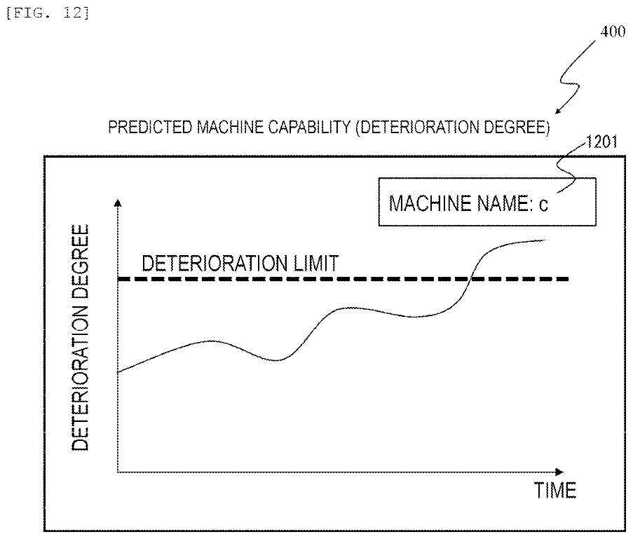

FIG. 12 is a diagram illustrating an example of a data structure of machine capability (deterioration degree). As illustrated in the figure, a machine capability model 400 is a set of information that predicts how the degree of deterioration, which is an index for specifying the performance of the machine, will change in the future with respect to specific information 1201 of the machine name. As a basic tendency, the degree of deterioration of the machine tends to increase with use, so when maintenance is neglected, the deterioration limit will be exceeded (broken) and it will not be possible to use it. Therefore, by using the machine capability model 400, it is possible to predict the time at which the deterioration degree of the machine capability (deterioration degree) exceeds the deterioration limit.

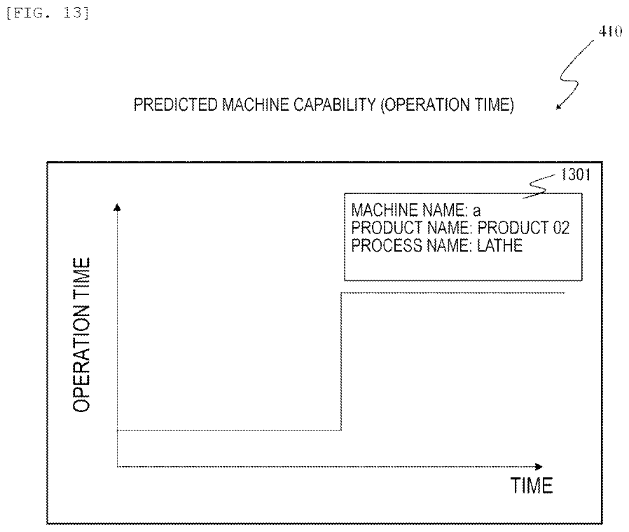

FIG. 13 is a diagram illustrating an example of a data structure of predicted machine capability (operation time). As illustrated in the figure, a machine capability model 410 is a set of information that predicts how the operation time for operating the process will change in the future for a specific information 1301 for each machine, product, and process. As a basic tendency, the performance of the machine deteriorates due to use and the operation time tend to increase, so when maintenance is neglected, the operation time will increase.

The production capacity prediction unit 113 predicts the production capacity of the entire factory by using the operation ability of the operator predicted by the operator ability prediction unit 111 and the operation capability of the machine predicted by the machine capability prediction unit 112.

Using the operation ability of an operator predicted by the operator ability prediction unit 111, the operation capability of a machine predicted by the machine capability prediction unit 112, and the production capacity of a factory predicted by the production capacity prediction unit 113, the planning unit 114 makes a factory plan that includes allocation of operations to operators and machines, education plans for operators, and maintenance plans for machines so as to optimize the plan according to the productivity indices, that is, the productivity index target information 129, which is the target value of the production throughput, the manufacturing cost, the operator's satisfaction degrees, and the like which are input from a user of the factory management device 100 via the input unit 130.

The input unit 130 receives input information from a manager via a user interface. The output unit 140 outputs information to the manager via the user interface. The communication unit 150 performs communication for exchanging information with other devices via various networks such as the Internet, an intranet, and an extranet.

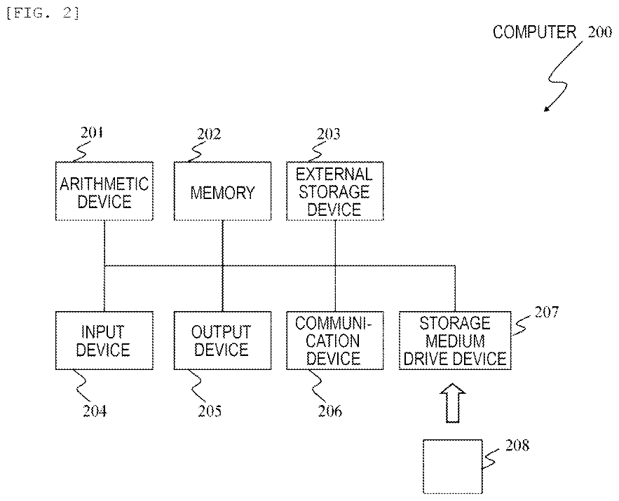

FIG. 2 is a diagram illustrating a hardware configuration example of the factory management device. A computer 200 which realizes the factory management device 100 includes an arithmetic device 201, a memory 202, an external storage device 203, an input device 204, an output device 205, a communication device 206, and a storage medium drive device 207.

The arithmetic device 201 is, for example, a central processing unit (CPU) or the like. The memory 202 is a volatile and/or non-volatile memory. The external storage device 203 is, for example, a hard disk drive (HDD), a solid state drive (SSD), or the like. The storage medium drive device 207 can read and write information from and to, for example, a compact disk (CD, a registered trademark), a digital versatile disk (DVD, a registered trademark), or any other portable storage medium 208. The input device 204 is a keyboard, a mouse, a microphone, or the like. The output device 205 is, for example, a display device, a printer, a speaker, or the like. The communication device 206 is, for example, a network interface card (NIC) for connecting to a communication network (not illustrated).

Each part of the processing unit 110 of the factory management device 100 can be realized by loading a predetermined program into the memory 202 and executing the program by the arithmetic device 201. This predetermined program may be downloaded from the storage medium 208 via the storage medium drive device 207 or from the communication network via the communication device 206 to the external storage device 203 and loaded into the memory 202, and then the program may be executed by the arithmetic device 201.

Further, the program may be directly loaded into the memory 202 from the storage medium 208 via the storage medium drive device 207 or from the communication network via the communication device 206 and executed by the arithmetic device 201. Alternatively, a part or ail of each part, of the processing unit 110 may be realized as hardware by a circuit or the like.

Further, the storage unit 120 of the factory management device 100 can foe realized by all or a part of the memory 202, the external storage device 203, the storage medium drive device 207, the storage medium 203, and the like. Alternatively, the storage unit 120 may be realized by the arithmetic device 201 controlling all or a part of the memory 202, the external storage device 203, the storage medium drive device 207, the storage medium 208, and the like by executing the program described above.

Further, the output unit 140 of the factory management device 100 can be realized by the output device 205. Alternatively, the output unit 140 may be realized by the arithmetic device 201 controlling the output device 205 by executing the program described above.

Further, the input unit 130 of the factory management device 100 can be realized by the input device 204. Alternatively, the input unit 130 may be realized by the arithmetic device 201 controlling the input device 204 by executing the program described above.

Further, the communication unit 150 of the factory management device 100 can be realized by the communication device 206. Alternatively, the communication unit 150 may toe realized toy the arithmetic device 201 controlling the communication device 206 by executing the program described above.

Further, each part of the factory management device 100 may toe realized by one device, or may be distributed and realized toy a plurality of devices.

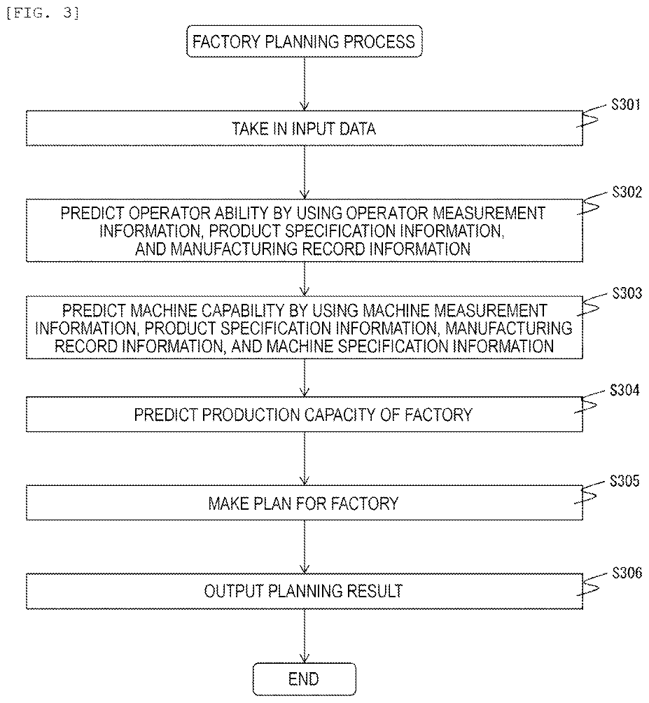

FIG. 3 is a diagram illustrating an example of a flow of a factory planning process. When the factory management device 100 receives an instruction from a manager via the input unit 130 or the communication unit 150, the factory management device 100 starts the factory management process.

First, the processing unit 110 of the factory management device 100 takes in the input data from the storage unit 120 via the input unit 130 (step S301). The input data includes all the data of the storage unit 120, but what is taken in here is sufficient address information for referencing all the data of the storage unit 120.

Next, the operator ability prediction unit 111 predicts the operator ability by using the operator measurement information 121, the product specification information 126, and the manufacturing record information 127 (step S302). Specifically, the operator ability prediction unit 111 learns the operator's operation time and operator's motivation by a method such as machine learning using the operator's traffic line (position) information, operation time information, and product specification information for each product and production process, and then the operator ability prediction unit 111 predicts the operator ability in chronological order using a learning completion model. The operator's ability predicted by the operator ability prediction unit 111 is treated as the operator ability models 300 and 310.

Next, the machine capability prediction unit 112 predicts the machine capability by using the machine measurement information 122, the product specification information 126, the manufacturing record information 127, and the machine specification information 128 (step S303). Specifically, the machine capability prediction unit 112 learns the degree of deterioration of the machine and the operation time by a method such as machine learning using the operation information of the machine, the operation time information, and the specification information of the product for each product and production process, and then the machine capability prediction unit 112 predicts the machine capability in chronological order using a learning completion model. The machine capability predicted by the machine capability prediction unit 112 is treated as the machine capability models 400 and 410.

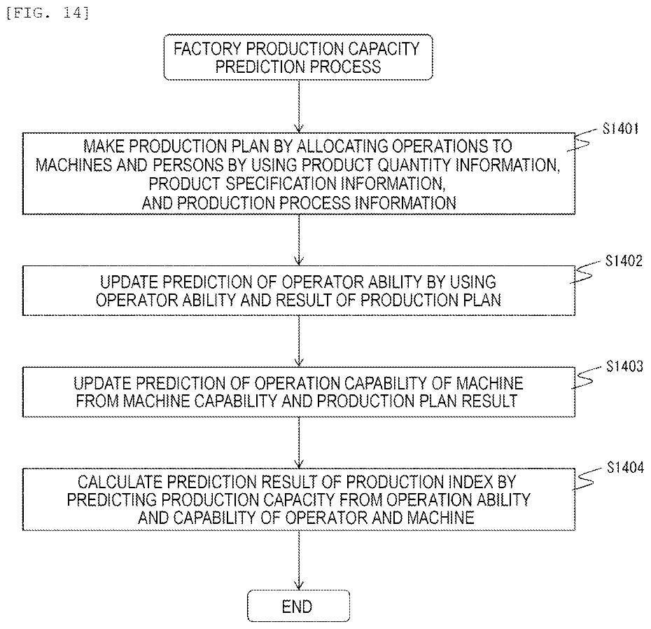

Then, the production capacity prediction unit 113 predicts the production capacity of the factory based on information on the operator ability prediction, the machine capability prediction, and the production process information 125 (step S304). The specific contents of the factory production capacity prediction process will be described below with reference to FIG. 14.

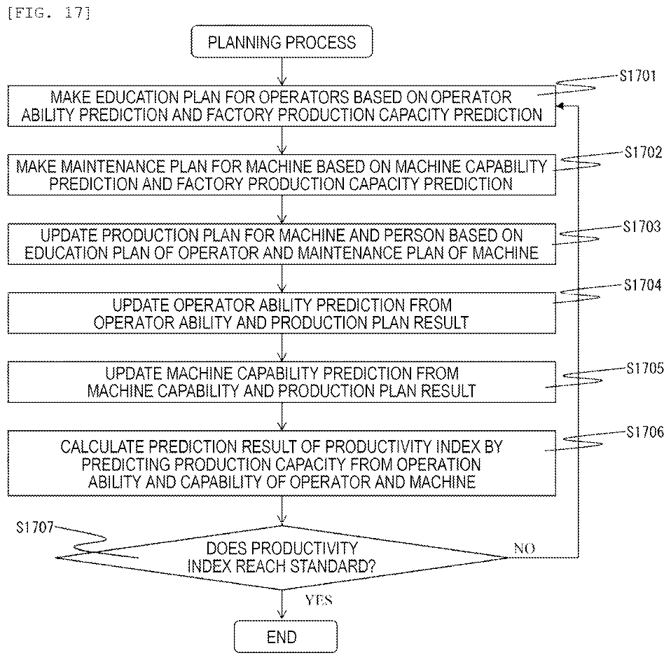

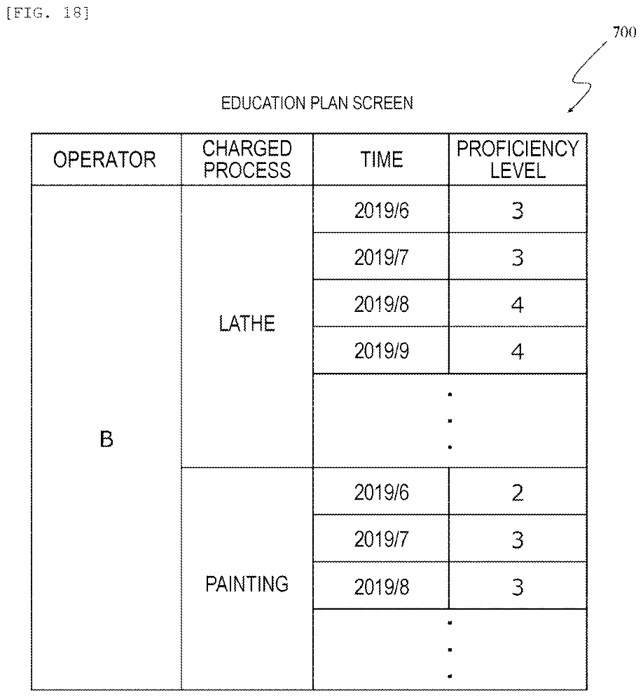

Then, the planning unit 114 makes a plan for the factory (step S305). The specific contents of the factory plan will be described below with reference to FIG. 17.

Then, the planning unit 114 outputs the education plan screen of the operator, the maintenance plan screen of the machine, and the allocation plan of operations to operators and machines as the planning result (step S306).

The above is the flow of a factory planning process. The factory planning process can be used to optimize factory management using information on the operation ability and capability of operators and machines.

FIG. 14 is a diagram illustrating an example of a flow of a factory production capacity prediction process. The factory production capacity prediction process is started in step S304 of the factory planning process.

First, the production capacity prediction unit 113 makes a production plan by allocating processes in the production process of a product to machines and persons as operations using the product quantity information 124, the product specification information 126, and the production process information 125 (step S1401). In this process, the operations are allocated to the operators and machines that can perform the production process and to which no operation has been allocated, focusing on the operation time of the operators and the operation time of the machines. In this operation allocation process, a production plan may be made by using an optimization method such as a mathematical planning method.

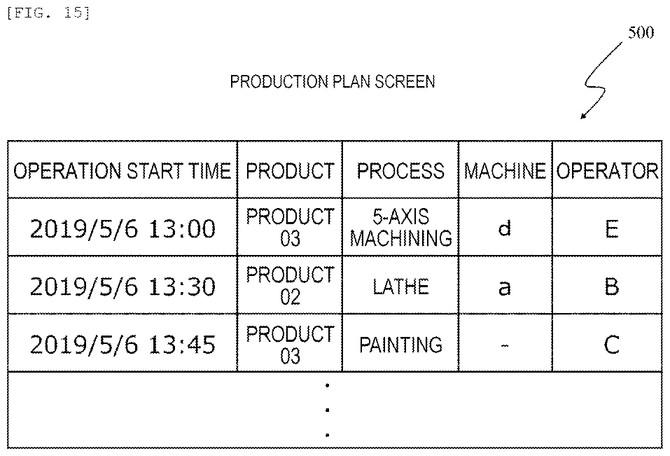

FIG. 15 is a diagram illustrating a configuration example of the production planning screen. As illustrated in the figure, the production plan is displayed on a production plan screen 500. In the production plan, the operation start time, the target products, the target processes, and the machines and operators that carry out the operations are associated with each other.

Then, the production capacity prediction unit 113 updates the prediction of the operator ability by using the operator ability and the result of the production plan (step S1402). By allocating operations, it is determined that which operation is to be performed in the future for each operator. Since operators are people and their operation abilities will change depending on the operation they perform in the future, the production capacity prediction unit 113 causes the operator ability prediction unit ill to predict the operation ability of the operator, and updates the operator ability models 300 and 310.

Then, the production capacity prediction unit 113 updates the prediction of the machine capability by using the machine capability and the result of the production plan (step S1403). Allocating operations determines which operation will be performed in the future for each machine. Since the operation capability of the machine changes depending on the amount of the operation to be performed in the future and the operation time, the machine capability models 400 and 410 are updated by causing the machine capability prediction unit 112 to predict the capability of the machine.

Then, the production capacity prediction unit 113 predicts the production capacity from the operation ability and capability of the operator and machine, and calculates the prediction result of the production index (step S1404). The production process information 125 indicates whether the process is performed by the operator alone or in collaboration with the machine and the operator. According to this, the production capacity prediction unit 113 predicts the capacity of the factory by the combination of the operator ability models 300 and 310 and the machine capability models 400 and 410, and calculates the prediction result for productivity indices such as production throughput, manufacturing cost, and operator's satisfaction degrees.

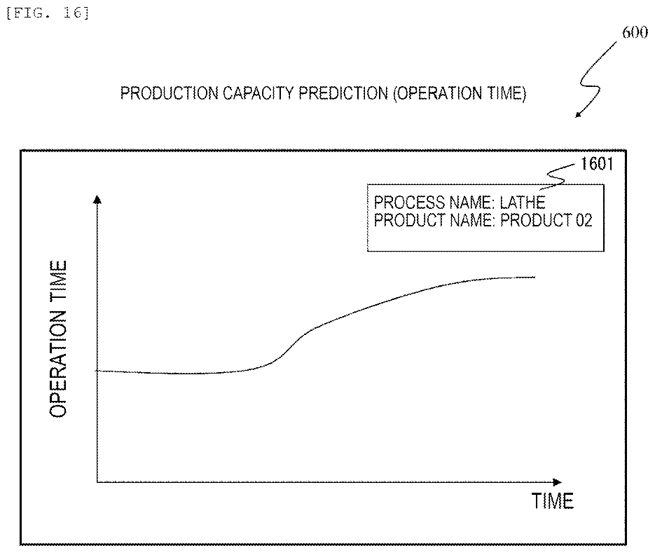

FIG. 16 is a diagram illustrating a configuration example of the production capacity prediction screen. As illustrated in the figure, a production capacity prediction screen 600 is a set of information that predicts how the production capacity (operation time) of each factory will change in the future with respect to specific information 1601 for each product and process. This makes it possible to predict the throughput of a product, for example, by combining the operation time of each process of the product.

The above is the flow of the factory production capacity prediction process. According to the factory production capacity prediction process, the production capacity can be predicted by using the ability and capacity of the operator and machine predicted in the production plan

FIG. 17 is a diagram illustrating an example of a flow of a planning process. The planning process is started in step S305 of the factory planning process.

First, the planning unit 114 makes an education plan for operators based on the operation ability prediction of an operator and the production capacity prediction of a factory (step S1701). The education plan for operators shows, for example, a growth curve of the proficiency level of the process that can be operated for each operator. Productivity indices are predicted according to the production capacity of the factory. Therefore, the planning unit 114 makes an education plan that takes into account the growth of the operator's proficiency level so that the productivity index is improved. For example, in the planning of this education plan, the planning unit 114 makes a plan by using an optimization method such as a mathematical planning method.

FIG. 13 is a diagram illustrating a configuration example of an education plan screen. As illustrated in the figure, the education plan is shown on an education plan screen 700, and the education plan is a set of information that predicts the proficiency level at a predetermined time for the combination of the operator and the process in charge. This makes it possible to estimate, for example, the proficiency level of an operator for each process at a certain time.

Next, the planning unit 114 makes a maintenance plan for the machine based on the machine capability prediction and the factory production capacity prediction (step 1702). The maintenance plan of a machine shows, for example, the maintenance type and maintenance time such as parts replacement and adjustment for each machine. Productivity indices are predicted according to the production capacity of the factory. Therefore, the planning unit 114 plans the maintenance of the machine so that the productivity index is improved. For example, in the planning of this maintenance plan, the planning unit 114 makes the plan by using an optimization method such as a mathematical planning method.

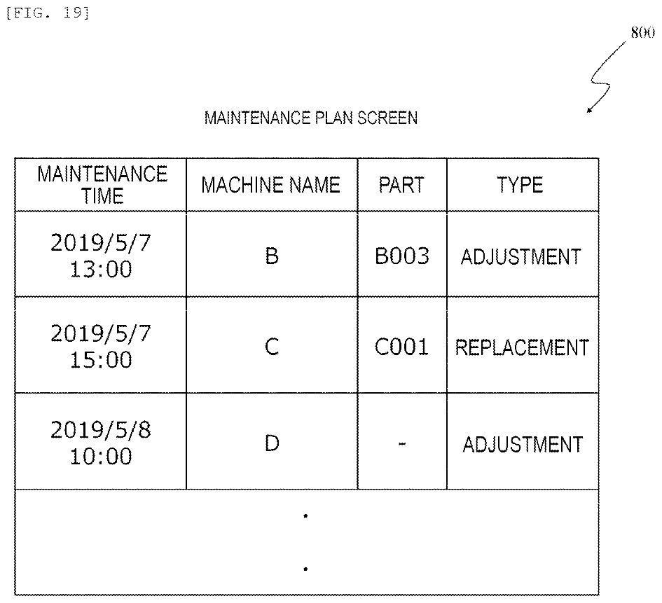

FIG. 19 is a diagram illustrating a configuration example of a maintenance plan screen. As illustrated in the figure, a maintenance plan screen 800 is a set of information in which the maintenance time, the maintenance target machine, the parts to be maintained, and the type of maintenance action are associated with each ether. As a result, for example, during the maintenance period of a machine, the machine can be excluded from the production plan and maintenance can be performed systematically.

Then, the planning unit 114 updates the operation allocation in the production plan including the allocation of the machines and the people based on the education plan for the operators and the maintenance plan for the machines (step S1703). In this step, depending on the production capacity that changes according to changes in future operator operation ability and machine operation capability due to the education plan for the operators and the maintenance plan for the machines, the planning unit 114 replans the operation allocation of operators and machines and updates the operation plan so as to optimize the productivity index. In predicting changes in production capacity, the operation ability and capability are predicted in chronological order using a learning completion model created by a learning method such as machine learning using the manufacturing record information 127 and the product specification information 126. In updating the operation allocation plan, the planning unit 114 makes a plan using an optimization method such as a mathematical planning method.

Then, the planning unit 114 updates the operator's operation ability prediction from the result of the production plan including the operator ability and the operation allocation (step S1704). Specifically, the planning unit 114 causes the operator ability prediction unit 111 to predict the operator ability, and updates the operator ability models 300 and 310.

Then, the planning unit 114 updates the prediction of the operation capability of the machine from the result of the production plan including the machine capability and the operation allocation (step S1705). Specifically, the planning unit 114 causes the machine capability prediction unit 112 to predict the capability of the machine and updates the machine capability models 400 and 410.

Then, the planning unit 114 predicts the production capacity from the operation ability and capacity of the operator and the machine, and calculates the prediction result of the productivity index (step S1706). The production process information 125 indicates whether the process is performed by the operator alone or in collaboration with the machine and the operator. According to this, the planning unit 114 causes the production capacity prediction unit 113 to predict the capacity of the factory by the combination of the operator ability models 300 and 310 and the machine capability models 400 and 410, and then the planning unit 114 calculates the prediction results for productivity indices such as production throughput, manufacturing cost, and operator's satisfaction degrees.

Then, the planning unit 114 determines whether the predicted result, of the predicted productivity index reaches a standard (target value of productivity index target information 129) (step SI707). When the target value is reached (when “YES” in step S1707), the planning unit 114 ends the planning process.

When the predicted result of the predicted productivity indicator does not reach the standard (target value of productivity index target information 129) (“NO” in step S1707), the planning unit 114 returns control to step S1701. This creates variable factors in the education plan for the operators, the maintenance plan for the machines, the machine-operator combination production plan, the operator ability prediction, the machine capability prediction, and the productivity index prediction, and by fluctuating these variable factors to make a plan, it is possible to make a plan for a factory in which productivity index will reach the standard.

The above is the factory management device 100 according to the first embodiment. According to the factory management device 100 according to the present embodiment, it is possible to automatically make a factory plan so as to optimize the management of the factory by using the information on the operation ability and capability of the operator and the machine.

The present invention is not limited to the embodiment described above, and includes various modification examples For example, the embodiment described above is described in detail in order to explain the present invention in an easy-to-understand manner, and is not necessarily limited to the one including all the described configurations.

For example, in the embodiment described above, the operator ability prediction unit 111 predicts, as a prediction of changes in operator ability, operation time as an objective ability and motivation (motivation for future actions) as a subjective ability, but the present invention is not limited to this. For example, the operation throughput (pieces/time), the fatigue degree (heart rate/average) may be predicted as objective abilities, and the satisfaction degree (satisfaction with the performed action) and the like may be predicted as subjective abilities.

Further, in the embodiment described above, the machine capability prediction unit 112 predicts, as a prediction of changes in the capability of the machine, the operation time and the degree of deterioration, but the present invention is not limited to this. For example, the failure probability may be predicted.

Further, in the embodiment described above, the production capacity prediction unit 113 predicts the operation time as a prediction of changes in the production capacity, but the present invention is not limited to this. For example, the factory throughput (pieces/day), manufacturing cost (price/piece), operator's satisfaction degrees, whether each operator retires, and the time of the retiring may be predicted.

Further, in the embodiment described above, the planning unit 114 may create a recruitment plan that determines the time and quantity of operators to be hired using the operator's retirement time and number of retired operators. Also, the planning unit 114 may create an investment plan such as expansion or replacement of the machine using the availability of the machine.

In addition, it is possible to add/delete/replace/integrate/distribute other configurations for a part of each configuration. Further, processes shown in the example may be appropriately distributed or integrated based on the processing efficiency or the mounting efficiency.

Further, each of the above-described parts, configurations, functions, processing units, and the like may be realized by hardware by designing a part or all of them by, for example, an integrated circuit. Further, each of the above-described parts, configurations, functions, and the like may be realized by software by the processor interpreting and executing a program that realizes each function. Information such as programs, tables, and files which realize each function can be placed in a memory, a recording device such as a hard disk or an SSD, or a recording medium such as an IC card, an SD card, or a DVD.

The control lines and information lines according to the embodiment described above are shown as necessary for explanation, and not ail control lines and information lines are necessarily shown in the product. In practice, it can be considered that almost all configurations are interconnected.

Further, the factory management device 100 described above may be a device which operates independently as described above, may be a device which operates by accessing a cloud service or the like, or may be a device which operates as a cloud server which operates when a request is received from another device and sends a result.

The present invention is described above with a focus on the embodiment.

### REFERENCE SIGNS LIST

100: factory management device

110: processing unit

120: storage unit

130: input unit

140: output unit

150: communication unit

111: operator ability prediction unit

112: machine capability prediction unit

113: production capacity prediction unit

114: planning unit

121: operator measurement information

122: machine measurement information

123: production resource information

124: product quantity information

125: production process information

126: product specification information

127: manufacturing record information

128: machine specification information

129: productivity index target information

201: arithmetic device

202: memory

203: external storage device

204: input device

205: output device

206: communication device

207: storage medium drive device

208: storage medium with portability

1. A factory management device which makes a plan for a factory, comprising:
a storage unit which stores operator measurement information obtained by measuring a movement of an operator and machine measurement information obtained by measuring a predetermined value which indicates an operating state of a machine that is production equipment of the factory;
an operator ability prediction unit which predicts changes in operation ability of the operator using the operator measurement information;
a machine capability prediction unit which predicts changes in operation capability of the machine using the machine measurement information;
a production capacity prediction unit which predicts a production capacity of the factory using prediction of changes in the operation ability and capability of the operator and the machine; and
a planning unit which makes a plan for the factory that satisfies a predetermined productivity index using the predicted production capacity of the factory.

2. The factory management device according to claim 1, wherein
in the storage unit, manufacturing record information which specifies a manufacturing record of a product of the factory and product specification information which specifies a specification of the product are stored, and
the operator ability prediction unit predicts changes in the operation ability of the operator by using the operator measurement information of the operator, the manufacturing record information, and the product specification information.

3. The factory management device according to claim 1, wherein
the storage unit stores manufacturing record information which specifies a manufacturing record of a product of the factory, product specification information which specifies a specification of the product, and machine specification information which specifies a specification of the machine, and
the machine capability prediction unit predicts changes in the operation capability of the machine by using the machine measurement information of the machine, the manufacturing record information, the product specification information, and the machine specification information.

4. The factory management device according to claim 1, wherein
the storage unit stores information on a result of a questionnaire response regarding an operation of the operator, and
the operator ability prediction unit creates a learning completion model by associating the result of the questionnaire response with the operator measurement information, and makes a prediction including any of operator's operation time, motivation, fatigue degrees, satisfaction degrees, and throughput by using the learning completion model.

5. The factory management device according to claim 1, wherein
the machine capability prediction unit creates a learning completion model using the machine measurement information, and makes a prediction including any of the machine including any of machine's operation time, deterioration degrees, and failure probability by using the learning completion model.

6. The factory management device according to claim 1, wherein
the production capacity prediction unit predicts a production capacity of the factory including any of factory throughput, manufacturing cost, and operator's satisfaction degrees by using changes in the operation ability of the operator predicted by the operator ability prediction unit and changes in the operation capability of the machine predicted by the machine capability prediction unit.

7. The factory management device according to claim 1, wherein
the planning unit makes an education plan showing the operation ability of the operator at a predetermined time, a maintenance plan of the machine at a predetermined time, and a production plan of allocating the operator and the machine to a predetermined process, and outputs the education plan, the maintenance plan, and the production plan.

8. The factory management device according to claim 1, wherein
the planning unit creates a recruitment plan including hiring time and quantity of the operator and an investment plan including expansion and replacement of the machine.

9. The factory management device according to claim 1, wherein
the production capacity prediction unit predicts the production capacity of the factory including any of throughput of the factory, manufacturing cost, and operator's satisfaction degrees by using changes in the operation ability of the operator predicted by the operator ability prediction unit and changes in the operation capability of the machine predicted by the machine capability prediction unit, and
the planning unit makes a plan by using a productivity index including any of the throughput of the factory, the manufacturing cost, and the operator's satisfaction degrees.

10. A factory management method for making a plan for a factory using a computer which includes a storage unit which stores operator measurement information obtained by measuring a movement of an operator and machine measurement information obtained by measuring a predetermined value which indicates an operating state of a machine that is production equipment of the factory, and a processing unit,
the method comprising:
with the processing unit, executing
an operator ability prediction process for predicting changes in operation ability of the operator using the operator measurement information,
a machine capability prediction process for predicting changes in operation capability of the machine using the machine measurement, information,
a production capacity prediction process for predicting a production capacity of the factory using prediction of changes in the operation ability and capability of the operator and the machine, and
a planning process for making a plan for the factory that satisfies a predetermined productivity index using the predicted production capacity of the factory.

11. A factory management program for a computer to function as a factory management device for making a plan for a factory,
the program causing the computer to operate
as a storage unit which stores operator measurement information obtained by measuring a movement of an operator and machine measurement information obtained by measuring a predetermined value which indicates an operating state of a machine that is production equipment of the factory and a processing unit, and
the program causing the processing unit to execute
an operator ability prediction process for predicting changes in operation ability of the operator using the operator measurement information,
a machine capability prediction process for predicting changes in operation capability of the machine using the machine measurement information,
a production capacity prediction process for predicting a production capacity of the factory using prediction of changes in the operation ability and capability of the operator and the machine, and
a planning process for making a plan for the factory that satisfies a predetermined productivity index using the predicted production capacity of the factory.
